(19) United States
(12) Patent Application Publication
(10) Pub. No.: US 2007/0143330 A1
(43) Pub. Date: Jun. 21, 2007

(54) Processing an XML schema

(76) Inventor: Harry Tang, Dunwoody, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 11/303,402

(22) Filed: Dec. 16, 2005

(51) Int. Cl. G06F 7/00

(52) U.S. Cl. 707/102

(57) ABSTRACT

Disclosed is a method of processing XML data for use in a software application program. The method takes an XML schema or XML data of the schema, generates xpath definitions for each XML data element from the schema, or generates an XSL file for each XML data element from the schema, and generates an alias file for the XSL file or xpath expression, the alias file containing XML tags for use in the software application program.

### TECHNICAL FIELD

The present disclosure is generally related to software and, more particularly, is related to a method for processing XML data for a software application program.

### BACKGROUND

Extensible Markup Language (XML) is a message format standard allowing different systems to communicate with each other. XML schema is widely used as a standard of formatting definitions for XML messages communicated between different software systems or applications. For example, a broadband virtual private network (VPN) service management system may involve many distributed systems, which transfer messages in the form of XML. An XML schema is a contract agreement of the format of the XML data. For a large XML message containing a large amount of data, the application needs to have a way to extract value from the XML raw message. More and more applications are processing XML messages, and the design of the XML processing algorithm affects the usability of a project implementing XML.

In reality, the XML schema definition could change frequently during a project to correct mistakes, to improve the data structures, or to introduce the new data components, among other nonlimiting examples. These changes may require the change of application codes based on the XML schema. Sometimes, the change could be very complicated if a program uses common XML processing tools, such as nonlimiting examples of JAXB (JAVA XML binding) or APIs (Application Program Interfaces), which increase the development effort in the project.

Programmers want a stable schema before designing the final code for processing the XML data. If the schema changes, the design code must be changed in accord with the new schema. In the data instructions, schema grammar is defined. Many projects are affected by the XML data passed between different systems. The requirements of the project may change and the XML data structure may change. When they change, the development process will be impacted due to changes in the development code corresponding to requirements of the new XML data. A common way to effect the changes uses a third party tool, such as the nonlimiting example of JAXB. If the schema is changed, the objects generated by JAXB are changed, and the development code must change.

In one non-limiting example, the XML data is passed between two systems, system 1 and system 2. The project involves the data paths between the two systems. The XML data is defined by the schema. The schema is used by one system to understand the XML data from the other system.

As shown in FIG. 1, a third party library such as JAXB 110 is used to analyze XML schema 100; it generates JAVA object libraries to be used in project 120. If something is changed in the schema 100, JAXB 110 must be processed again, changing the JAVA object libraries. Subsequently, project code 120 must be changed.

Another non-limiting example may include an instance of a provider such as BellSouth setting up a VPN service for a business customer, e.g., AT&T. An order preparation system may collect customer and network data and assemble it in XML format. This XML formatted data is provided to a separate service order processing system to parse and analyze the XML data. The output of the service order processing system is a service order for the AT&T service. A schema is used to define the format and structure of the XML data in the example above. Once the service is provisioned in the BellSouth network, AT&T locations can use the service to access their VPN.

Code is written in the project using the JAXB generated library to utilize the XML data that the upstream processing system provides. For example, when the customer contact information changes, the schema will have to change, and the users need to be able to incorporate the changes in any software program which utilizes the schema. The customer information may be the customer name, address, phone number. The tag name is what is changed. The customer name may initially include a first name and last name. After changes, it has combined first name, last name, and middle name. Alternatively, an e-mail address, phone number, or cell phone number may be added which was not present in the previous schema. When the JAXB library changes, the project code changes, and a regression test is performed to verify that the changes have been incorporated. The code relies on the libraries generated by JAXB based on the schema. Therefore, a small change in the schema could end up causing a large change in the project. Thus, a heretofore-unaddressed need exists in the industry to address the aforementioned deficiencies and inadequacies.

### SUMMARY

Embodiments of the present disclosure provide methods for processing an XML schema. In this regard, one embodiment of such a method, among others, can be broadly summarized by the following steps: receiving an XML schema of relations between XML data elements; generating xpath definitions or an XSL style sheet file for each XML data element from the XML schema; and generating an alias file for the xpath definitions or the XSL file. The alias file may comprise fixed alias tag names for use in a user application and corresponding xpath or XSL tags of elements from the XML schema.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a flow chart of a method of processing an XML schema as known in the prior art.

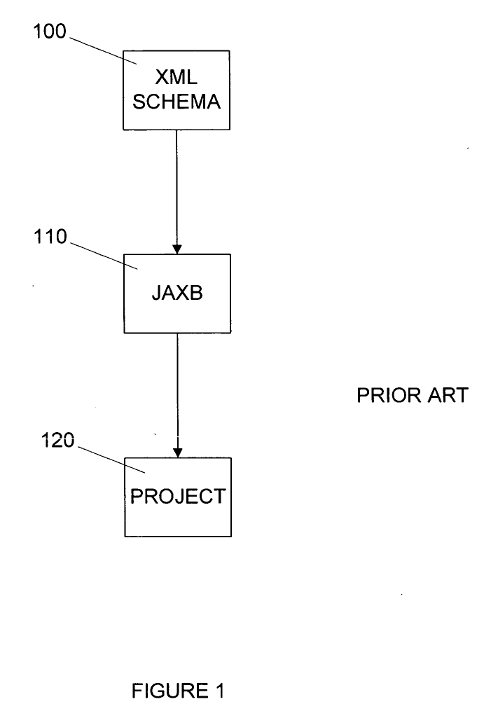

FIG. 2 is a flow chart of an exemplary embodiment of a method of processing an XML schema according to the present disclosure.

FIG. 3 is a block diagram of the tree structure of the XML schema of FIG. 2.

### DETAILED DESCRIPTION

Having summarized various aspects of the present disclosure, reference will now be made in detail to the description of the disclosure as illustrated in the drawings. While the disclosure will be described in connection with these drawings, there is no intent to limit it to the embodiment or embodiments disclosed herein. On the contrary, the intent is to cover all alternatives, modifications and equivalents included within the spirit and scope of the disclosure as defined by the appended claims.

Embodiments of this disclosure involve an algorithm applied to an XML schema file. XML schema are well defined according to the World Wide Web Consortium (W3C) XML schema specification, XML Schema: Primer Second Edition, published on Oct. 28, 2004, which is incorporated by reference. The key components of a schema are element, attribute, and associated type definition, i.e., simple or complex type structure. Embodiments of this disclosure process the schema file to generate a set of text expressions which can be used in end-user applications to extract XML element values. In this disclosure, a text expression may either be embodied in an Extensible Stylesheet Language (XSL) style sheet for each element or attribute, or in a specific XML Path Language (xpath) expression for each element or attribute. An xpath expression is written as a sequence of steps to get from one set of nodes to another set of nodes in a tree structure of an XML schema. Two similar methods may be used to evaluate XML data. An XSL style sheet may be utilized by a standard XSL translator or the xpath expression may be used by a standard xpath library to retrieve the value corresponding to an XML data element as defined by the schema.

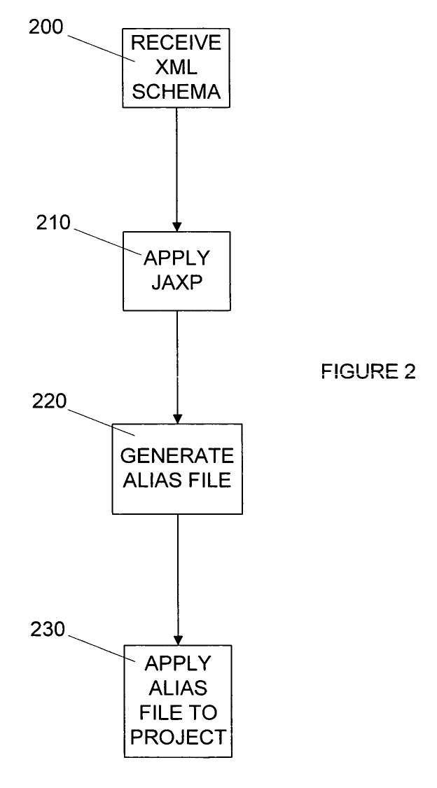

FIG. 2 provides a flow diagram for an exemplary embodiment of a method of processing XML for use in an application program. In block 200, an XML schema is received. The XML schema may define attributes of an element and/or any relation between multiple elements. In block 210, a JAVA program is used to parse the elements of the XML schema received in block 200. A non-limiting example of the JAVA program is JAXP. In block 220, an alias file is generated to generate aliases for the element of the XML schema. In block 230, the aliases from the alias file are used in the project or user application program.

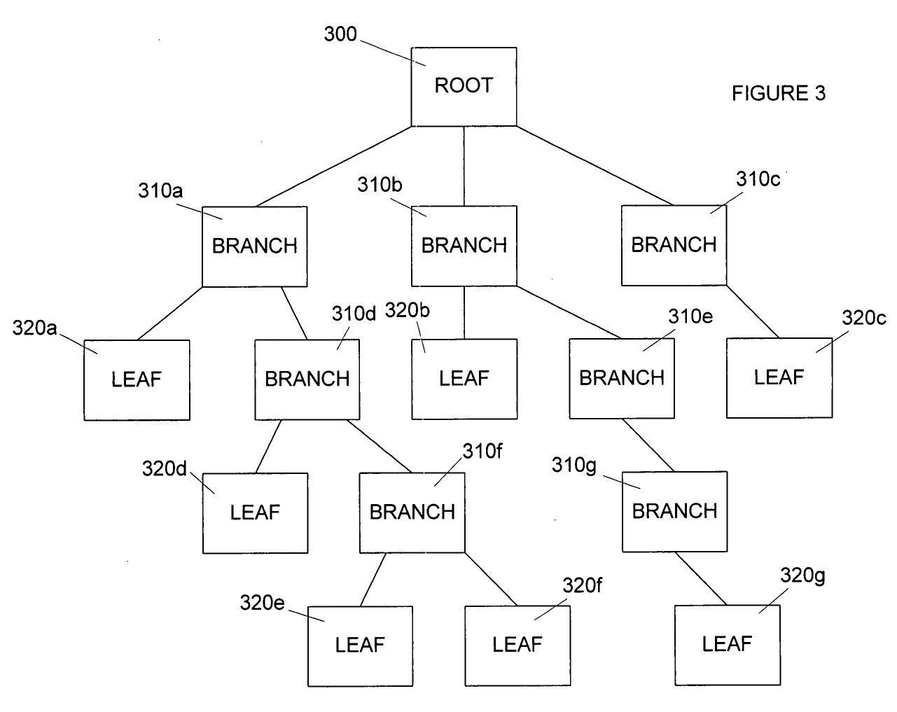

An exemplary embodiment of the algorithm may define branch nodes and leaf nodes of a tree structure of an XML schema as provided in FIG. 3. A leaf node 320 represents an element or attribute whose type is defined as a simple type according to W3C XML schema. A branch node 310 is an element whose type is complex type, which means it contains at least one other element or attribute inside of its structure. The algorithm is implemented in a standalone JAVA program. The JAVA program defines branch node 310 and leaf node 320 sub classes. There is also a root element 300 in the schema, which is the starting branch node for the algorithm. The JAVA program employs a parent node and child node concept for each branch node 310 or leaf node 320, which represents the positional relation of the nodes. For example, a branch node 310 is a complex type and contains many elements inside of its complex type definition. The branch node 310 is a parent node for element nodes within its complex type definition; and each element is a child node of that branch node 310. The child node could be either a branch node 310 or a leaf node 320 depending on whether it is a simple type or complex type.

The algorithm starts from the root element 300 and recursively processes each element (or attribute) node in the tree structure. This process continues until all the elements have been processed, the leaf node 320 being reached in each limb of the tree. Once the algorithm travels and reaches leaf node 320, it records the “path” from root element 300 to leaf node 320, and the path is used to build the XSL style sheet or xpath for the leaf node 320.

In a non-limiting example, referring again to FIG. 3, the algorithm begins at root node 300 and travels through branch node 310a to leaf node 320a. The path to leaf node 320a is recorded. The algorithm then travels back up to the nearest branch node 310a, and back down through branch node 310d to leaf node 320d. The path to leaf node 320d is recorded. The algorithm travels back up to branch node 310d and down through branch 310f to leaf node 320e. The path to leaf node 320e is recorded. The algorithm then travels back up to branch node 310f and down to leaf node 320f. The path to leaf node 320f is recorded.

The algorithm then travels back up through branch node 310f, 310d, and 310a, to reach root node 300. It then travels down the next unprocessed limb of root node 300 (which is also a branch node) through branch node 310b to leaf node 320b. The path to leaf node 320b is recorded. After reaching leaf node 320b, the algorithm proceeds up the limb to the first branch node with an unprocessed limb. In this case, the algorithm proceeds up to branch node 310b and down through branch nodes 310e and 310g to leaf node 320g. The path to leaf node 320g is recorded. The algorithm then proceeds back up the limb through branch nodes 310g, 310e, and 310b to root node 300 again. There is still an unprocessed limb off of root node 300, so the algorithm proceeds down through branch node 310c to leaf node 320c. The path to leaf node 320c is recorded. The algorithm then proceeds back up through branch node 310c to root node 300 and determines that there are no unprocessed limbs off of root node 300. Therefore the algorithm has completed the process.

In the XML schema, some elements may occur more than once, e.g., multiple items in a purchase order. In this case, a special XSL style sheet is composed in order to catch and distinguish multiple instances of this element in the XML text. If the repeatable element were a complex type, the style sheet would transform the complex type element into text form containing every subelement.

If an XSL style sheet approach is used, after an XSL style sheet is constructed, the algorithm saves them into individual files with unique names. A cached file name structure is also used in the JAVA program. For leaf elements of same name ending on different tree branches, a unique appendix is added to the file name to make them distinguishable. If an xpath approach is used, xpath expressions for each of the elements or attributes may be saved to a single file, and each element or attribute corresponds to a unique name.

The following is the example to use these XSL style sheets in a practical application. An XML message is widely used as a communication message between two systems. Each system has to follow the XML schema agreed upon by both systems. Suppose system A sends an XML message to system B. System B uses style sheet definitions to extract values for each element appearing in the XML message sent by system A. The extraction may use a standard XSL translator library to apply the style sheet for each element to retrieve its value. If the xpath approach is utilized, system B loads all xpath definitions in its memory at the starting time.

When it receives the XML message from A, a standard xpath API library can be applied to the xpath expression for each element, and the value of the element is retrieved if it is in the XML message, or sets it to null if it is not in XML data. Some elements may be optional. If, for example, the schema needs to be updated, the disclosed JAVA program is applied to the new schema, and a set of new style sheets or xpaths is extracted for each element or attribute. For new elements introduced to the schema, system B adds new style sheets or xpath expressions corresponding to any new element. If the existing element name in the schema is changed, the modification on an end-user application is limited to the elements that were added or changed. Therefore, the change would be minimal, because the expression for the non-changing elements does not change. However, if using technologies such as JAXB to parse the XML, the change is expanded to rewrite interface structures to reflect the new schema.

Exemplary embodiments have less impact when the XML schema is modified. If a further separation is needed to isolate application code to change an XSL style sheet or xpath due to a schema change, an alias file can be introduced with the format “element alias, expression name.” The “element name” tag is fixed for use in the end-user application, and the “expression name” tag is the style sheet name or xpath name for each element or attribute. If a schema change affects an existing element, the disclosed JAVA program may generate slightly different expression names for style sheet files or xpaths along with their contents. However, if an alias file is modified with the proper “expression name” tags, the end-user application may remain unchanged, as it uses only an element alias in the code. Therefore, there is no end-user code change and no regression test is necessary.

If a new element is added to the schema, a new entry, “element alias, expression name” may be added in the alias file. The end-user application code may also add processing for this new “element alias” tag. However, the change to the end-user code will be minimal, isolated only to the new tags; it does not affect other tags.

An exemplary embodiment of the disclosed algorithm may use the xpath approach, generating the following exemplary xpath expressions in an xpath file.

message_system=/message/@system
message_clientId=/message/@clientId
message_priority=/message/@priority
message_messagePersistenceService=/message/@messagePersistence-
Service
message_timeToLive=/message/@timeToLive
billing_serviceID=/message/billing/serviceID
billing_orderID=/message/billing/orderID
...

An exemplary alias file for the xpath expressions may include:

system_alias=message_system
clientId_alias=message_clientId
priority_alias=message_priority
messagePersistenceService_alias=message_messagePersistenceService
timeToLive_alias=message_timeToLive
serviceID_alias=billing_serviceID
orderID_alias=billing_orderID
...

If the schema is changed, for example, an element tag name change, the xpath expression file generated by the disclosed algorithm may change on both the left and right side of the “=” sign. However, if the right side of the alias file is updated due to a possible change of “expression name,” the left side may remain unchanged. The end-user application software only uses the expressions on the left side of the “=” in the alias file, which may remain constant. The xpath file and alias file can be loaded into the end-user application memory dynamically on demand.

The disclosed JAVA application program can generate the XSL style sheet file for each element or attribute, or xpath expression for each element or attribute. In order to generate an XSL style sheet or xpath expression for an XML element or attribute, the disclosed application program can either generate from the XML schema directly or generate from valid XML data according to the XML schema. The method of using XML data in the disclosed algorithm is similar to the method of using the schema in the disclosed algorithm. Both methods may define branch nodes and leaf nodes when generating expressions.

If the disclosed algorithm uses a schema, a branch node corresponds to a complex data type in the schema. The syntax for a complex type element in an exemplary embodiment may include <complexTypename=“elemName”>. The definition may include other complex type elements or simple type elements before the close tag for a complex type element occurs. An exemplary embodiment of a close tag for a complex type element may be </complexType>. The syntax for a simple type element in an exemplary embodiment of a schema may include <simpleType>, followed by a simple type definition and a close tag such as </simpleType>. If the disclosed JAVA application program identifies a simple type element in the schema, the element may be determined to be a leaf node. If the disclosed JAVA application program identifies a complex type element in the schema, the definition may be determined to be a branch node. The disclosed algorithm may build a node tree by iteratively progressing through the schema. If a second complex type element occurs within another first complex element, the disclosed algorithm inserts the second complex element as a child branch node of a parent branch node. The parent branch node corresponds to the first complex element. When a leaf node is found, the end of the path is reached and the disclosed algorithm adds the complete path from a root node to this leaf node. The algorithm then progresses back to determine the next leaf node in the tree. This process is performed recursively until all nodes have been determined.

Valid XML data can be generated from the predefined XML schema using tools such as XMLSPY. If the disclosed algorithm uses such XML data, the algorithm for generating the style sheet or xpath expression for each element or attribute is similar for generating the style sheet or xpath expression using the XML schema.

When using an XML source file, again a leaf node corresponds to a simple type element, and there is no other element tag between an open tag and a close tag. As a non-limiting example, a simple type element may be defined as <element1>value</element 1>. A branch node corresponds to a complex type element. As a non-limiting example, a complex type element may be defined as

<element1>
<element2>value2</element2>
<element3>value3</element3>
...
</element1>

The element <element1>is a complex type element, as it contains other element tags before its closing tag </element>. Such a complex type element is added to the node tree as a branch node. The disclosed algorithm walks through the entire node tree and builds an XSL style sheet or xpath when a leaf node is determined.

Embodiments of the present disclosure can be implemented in hardware, software, firmware, or a combination thereof. Some embodiments can be implemented in software or firmware that is stored in a memory and that is executed by a suitable instruction execution system. If implemented in hardware, an alternative embodiment can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow charts should be understood as representing modules, segments, or portions of code which include one or more executable instructions for implementing specific logical functions or steps in the process, and alternate implementations are included within the scope of an embodiment of the present disclosure in which functions may be executed out of order from that shown or discussed, including substantially concurrently or in reverse order, depending on the functionality involved, as would be understood by those reasonably skilled in the art of the present disclosure.

The XML schema processing program, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory. In addition, the scope of the present disclosure includes embodying the functionality of the illustrated embodiments of the present disclosure in logic embodied in hardware or software-configured mediums.

It should be emphasized that the above-described embodiments of the present disclosure, particularly, any illustrated embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

1. A method of processing XML data for a software application program comprising:
receiving an XML schema of relations between XML data elements;
generating xpath definitions or an XSL style sheet file for each XML data element from the XML schema; and
generating an alias file for the xpath definitions or the XSL file, the alias file comprising:
fixed alias tag names for use in a user application; and
corresponding xpath or XSL tags of elements from the XML schema.

2. The method of claim 1, wherein the XSL style sheets or xpath definitions are generated with a JAVA application.

3. The method of claim 2, wherein the generating an alias file comprises generating an alias file with a recursive tree structure algorithm.

4. The method of claim 1, wherein the elements are characterized as branches, leaves, or a root element of a tree structure.

5. The method of claim 1, further comprising:
determining whether the elements are complex or simple.

6. The method of claim 5, wherein if an element is a complex type element and occurs multiple times in the XML schema, an XSL style sheet file is generated for the element.

7. The method of claim 4, wherein the generating XSL style sheet or xpath definitions comprises recursively processing each element in the XML schema.

8. The method of claim 7, wherein the recursive processing comprises:
processing each element in a tree structure beginning with a root element;
traveling down a limb until a leaf is reached;
traveling up the limb until a branch is reached;
traveling down the unprocessed side of the limb until another leaf is reached; and
repeating the process until no unprocessed element is present.

9. A computer readable medium with a software program for performing a method of processing XML data for a software application program comprising:
logic for receiving an XML schema of relations between XML data elements;
logic for generating xpath definitions or an XSL style sheet file for each XML data element from the XML schema; and
logic for generating an alias file for the xpath definitions or the XSL file, the alias file comprising:
fixed alias tag names for use in a user application; and
corresponding xpath or XSL tags of elements from the XML schema.

10. The computer readable medium of claim 9, wherein the logic for generating XSL style sheets or xpath definitions comprises a JAVA application.

11. The computer readable medium of claim 10, wherein the logic for generating an alias file comprises logic for generating an alias file with a recursive tree structure algorithm.

12. The computer readable medium of claim 9, further comprising logic for characterizing the elements as branches, leaves, or a root element of a tree structure.

13. The computer readable medium of claim 9, further comprising:
logic for determining whether the elements are complex or simple.

14. The computer readable medium of claim 13, further comprising logic for generating an XSL style sheet file for an element if the element is a complex type element and occurs multiple times in the XML schema.

15. The method of claim 12, wherein the logic for generating XSL style sheet or xpath definitions comprises logic for recursively processing each element in the XML schema.

16. The method of claim 15, wherein the logic for recursive processing comprises:
logic for processing each element in a tree structure beginning with a root element;
logic for traveling down a limb until a leaf is reached;
logic for traveling up the limb until a branch is reached;
logic for traveling down the unprocessed side of the limb until another leaf is reached; and
logic for repeating the process until no unprocessed element is present.

17. A system for processing XML data for a software application program comprising:
means for receiving an XML schema of relations between XML data elements;
means for generating xpath definitions or an XSL style sheet file for each XML data element from the XML schema; and
means for generating an alias file for the xpath definitions or the XSL file, the alias file comprising:
fixed alias tag names for use in a user application; and
corresponding xpath or XSL tags of elements from the XML schema.
